(19) United States
(12) Patent Application Publication
(10) Pub. No.: US 2010/0030917 A1
(43) Pub. Date: Feb. 4, 2010

(54) Signal processing apparatus, signal processing method, and program

(75) Inventor: Shuji Kaneko, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/460,718

(22) Filed: Jul. 23, 2009

(30) Foreign Application Priority Data
Jul. 25, 2008 (JP) P2008-192095

(51) Int. Cl. G06F 3/00

(52) U.S. Cl. 710/1

(57) ABSTRACT

A signal processing apparatus includes: a connecting means for use in connecting to a different device; a signal control means for changing a control signal to be outputted to the different device through the connecting means for a predetermined period; a changing means for changing the predetermined period; a determining means for determining for each of the predetermined periods changed by the changing means whether the different device stably makes a response to a change in the control signal caused by the signal control means; and a deciding means for deciding a shortest predetermined period from the predetermined periods determined by the determining means that the different device stably makes a response, as a standby time for the different device connected through the connecting means.

### CROSS-REFERENCE TO RELATED APPLICATION

The present application claims priority from Japanese Patent Application No. JP 2008-192095 filed in the Japanese Patent Office on Jul. 25, 2008, the entire content of which is incorporated herein by reference.

### BACKGROUND OF THE INVENTION

1. Field of the Invention

The present invention relates to a signal processing apparatus, a signal processing method, and a program, and particularly to a signal processing apparatus, which can control a different device in the optimum standby time, a signal processing method, and a program.

2. Description of the Related Art

In recent years, as the interface standards used for connecting so-called digital electric home appliances to each other such as digital television sets, digital video cameras, digital video recorders, digital players, digital tuners, and home-use game machines, the HDMI (High-Definition Multimedia Interface) standard is widely used, and HDMI devices provided with a terminal in conformity with the HDMI standard are increasing.

Hereinafter, among HDMI devices provided with a terminal in conformity with the HDMI standard, an HDMI device that supplies a content formed of video and sounds is called a source device such as a DVD (Digital Versatile Disc) player. In addition, an HDMI device that outputs a content fed from a source device is called a sink device such as a television set (the device that displays video and outputs sounds).

In addition, between the source device and the sink device, control signals are sent and received for device authentication and various settings. For example, by a hot plug signal, the sink device notifies the source device that it is possible to read EDID (Extended Display Identification Data) including information such as the maximum resolution or color characteristics of a display, or that it is compliant with an HDCP (high-bandwidth Digital Content Protection) authentication process, which is one of copyright protection techniques.

In the past, generally, when a plurality of source devices is connected to a sink device through HDMI terminals, a source device is selected (specified) so as to supply a content to the sink device, and turned into the selected state, whereas a source device, which is not selected to do so, is turned into the unselected state. Then, in the sink device, such control is conducted in which the hot plug signal of the HDMI terminal connected to the source device in the selected state is turned to high level, and the hot plug signal of the HDMI terminal connected to the source device in the unselected state is turned to low level.

Some sink devices are mounted with a CEC (Consumer Electronics Control) function that is the function of controlling devices each other. For such sink devices, it is necessary to always keep all the hot plug signals of the HDMI terminals high in order to read EDID of the source device in the unselected state all the time. Then, in response to a user manipulation, for example, when the selection of the source device is switched, the sink device conducts such control (toggling) that the sink device turns the hot plug signal of the HDMI terminal to low level, waits for a predetermined period, and again turns the HDMI terminal to high level, the HDMI terminal being connected to the source device to be newly turned into the selected state.

When the sink device conducts the toggling of the hot plug signal in this manner, in response to the toggling, the source device again conducts the HDCP authentication process to perform a process of recovering from the HDCP error state (reset).

For example, in the HDMI standard, it is defined that when the hot plug signal continues the low state for a period of 100 milliseconds or longer, that is, when the low period (the period in which the sink device turns the hot plug signal to low level and waits) of the hot plug signal is 100 milliseconds or longer, the source device detects that the hot plug signal is turned to low level and responds to the detection. However, among source devices already available on the market, some of source devices can respond to the event that the hot plug signal is turned to low level after a much longer low period of the hot plug signal than a period of 100 milliseconds, that is, some source devices have a long response time.

In order to keep compatibility with such source devices having a long response time, it is necessary to set the low period of the hot plug signal to a period of 100 milliseconds or longer as matched with the source device having a long response time. However, because all the source devices connected to the sink device do not always have a long response time, when the low period of the hot plug signal is set longer, the low period becomes unnecessarily longer depending on source devices. Therefore, a user has to wait for a longer time until a sink device outputs a content after the selection of a source device is switched.

For example, Patent Document 1 describes a technique that uses a hot plug signal to detect the connection between HDMI devices. (See JP-A-2008-35060.)

### SUMMARY OF THE INVENTION

As described above, an unnecessarily long low period is sometimes set to sink devices before, and a user feels a poor response to manipulations at times. From this point, such a sink device is demanded that the sink device controls a source device in the optimum low period and has an excellent response to manipulations.

Thus, it is desirable to allow control over a different device in the optimum standby time.

According to an embodiment of the invention, there is provided a signal processing apparatus including: a connecting means for use in connecting to a different device; a signal control means for changing a control signal to be outputted to the different device through the connecting means for a predetermined period; a changing means for changing the predetermined period; a determining means for determining for each of the predetermined periods changed by the changing means whether the different device stably makes a response to a change in the control signal caused by the signal control means; and a deciding means for deciding a shortest predetermined period from the predetermined periods determined by the determining means that the different device stably makes a response, as a standby time for the different device connected through the connecting means.

According to another embodiment of the invention, there is provided a signal processing method of a signal processing apparatus for processing a signal, including the steps of: by the signal processing apparatus, changing a control signal to be outputted to a different device through a connecting means for use in connecting to the different device for a predetermined period; changing the predetermined period; determining for each of the changed predetermined period whether the different device stably makes a response to a change in the control signal; and deciding a shortest predetermined period from the predetermined periods determined that the different device stably makes a response, as a standby time for the different device connected through the connecting means.

According to still another embodiment of the invention, there is provided a program which allows a computer to function as a signal processing apparatus for processing a signal, including the functions of: a signal control means for changing a control signal to be outputted to the different device through a connecting means for use in connecting to a different device for a predetermined period; a changing means for changing the predetermined period; a determining means for determining for each of the predetermined periods changed by the changing means whether the different device stably makes a response to a change in the control signal caused by the signal control means; and a deciding means for deciding a shortest predetermined period from the predetermined periods determined by the determining means that the different device stably makes a response, as a standby time for the different device connected through the connecting means.

According to the embodiments of the invention, a control signal is changed for a predetermined period, the control signal being outputted to a different device through a connecting means for use in connecting to the different device. Then, the predetermined period is changed, it is determined for each of the changed predetermined periods whether the different device stably makes a response to a change in the control signal, and the shortest predetermined period is decided from the predetermined periods determined that a different device stably makes a response, as a standby time for a different device connected through the connecting means.

According to the embodiments of the invention, control is allowed over a different device in the optimum standby time.

### BRIEF DESCRIPTION OF THE DRAWINGS

FIG. 1 is a block diagram depicting an exemplary configuration of an embodiment of a sink device to which the invention is adapted;

FIG. 2 is a diagram depicting changes in hot plug signals;

FIG. 3 is a flowchart illustrative of a low period optimization process; and

FIG. 4 is a flowchart illustrative of an input switching process.

### DESCRIPTION OF THE PREFERRED EMBODIMENTS

Hereinafter, a specific embodiment to which the invention is adapted will be described in detail with reference to the drawings.

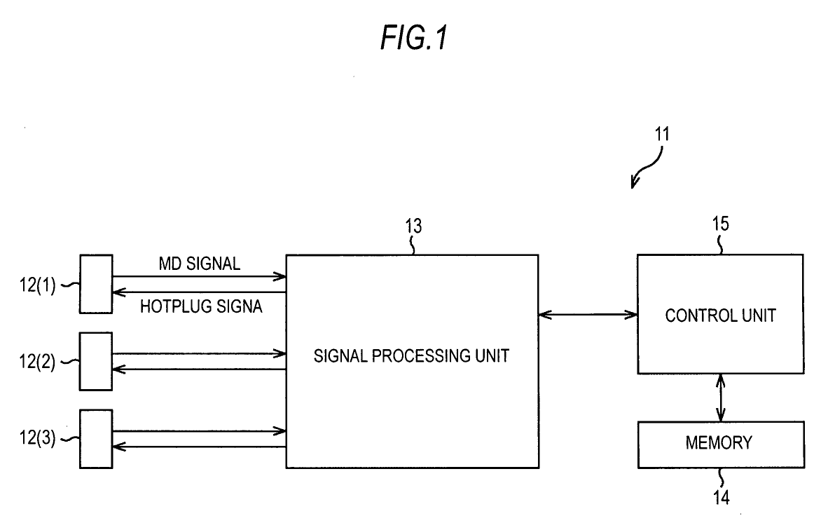

FIG. 1 is a block diagram depicting an exemplary configuration of an embodiment of a sink device to which the invention is adapted.

In FIG. 1, a sink device 11 is configured of three HDMI terminals 12(1) to 12(3), a signal processing unit 13, a memory 14, and a control unit 15.

The HDMI terminal 12(1) to the HDMI terminal 12(3) are connecting means in conformity with the HDMI standard, each of which connects a source device, not shown, to the sink device 11 through an HDMI cable, not shown.

The signal processing unit 13 processes signals sent and received from source devices individually connected to the HDMI terminal 12(1) to the HDMI terminal 12(3) under control performed by the control unit 15. For example, when a TMDS (Transition Minimized Differential Signaling) signal, which is a signal for transmitting content data, is sent from the source device, the signal processing unit 13 receives and supplies the TMDS signal to a circuit in the later stage, not shown (for example, a decryption circuit or a display circuit). In addition, the signal processing unit 13 controls switching between high and low levels of a control signal to be outputted to the source device through the HDMI terminal 12(1) to the HDMI terminal 12(3).

In addition, the signal processing unit 13 has a switching function of switching inputs such that a given source device among a plurality of the source devices connected through the HDMI terminal 12(1) to the HDMI terminal 12(3) supplies a content to the sink device 11. More specifically, the signal processing unit 13 has the switching function, whereby the sink device 11 can be mounted with a plurality of HDMI terminals.

The memory 14 is formed of a non-volatile flash memory (for example, EEPROM (Electronically Erasable and Programmable Read Only Memory)) that can be controlled to read and write data by the control unit 15. The memory 14 stores a program performed by the control unit 15 and data necessary to conduct a process performed by the control unit 15.

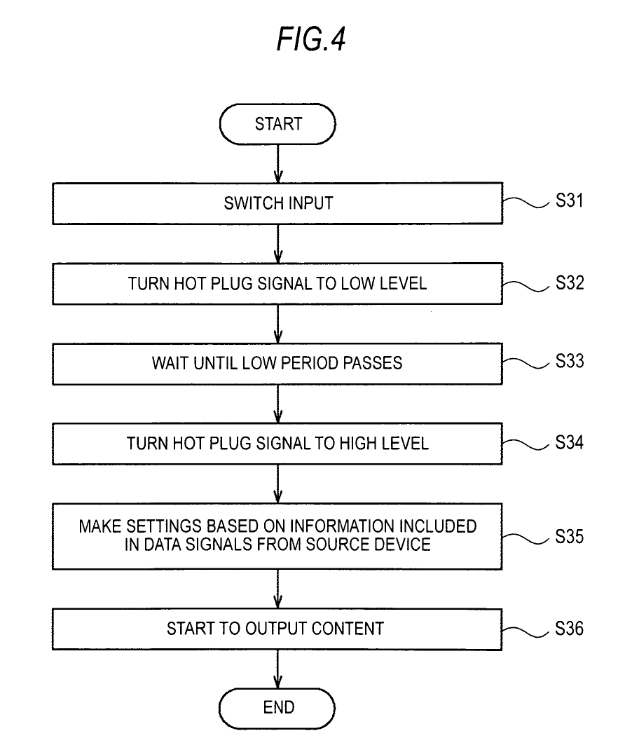

For example, the memory 14 stores information for each of the HDMI terminal 12(1) to the HDMI terminal 12(3), the information indicating a standby time for which a hot plug signal is turned to low level for waiting in an input switching process (a process shown in FIG. 4, described later) in which the source device that inputs a content to the sink device 11 is switched. (Hereinafter, the information is properly referred to as a low period T_LOW of the hot plug signal). In other words, the memory 14 stores a low period T_LOW (1) to a low period T_LOW (3) of the hot plug signals as they are associated with the HDMI terminal 12(1) to the HDMI terminal 12(3), respectively.

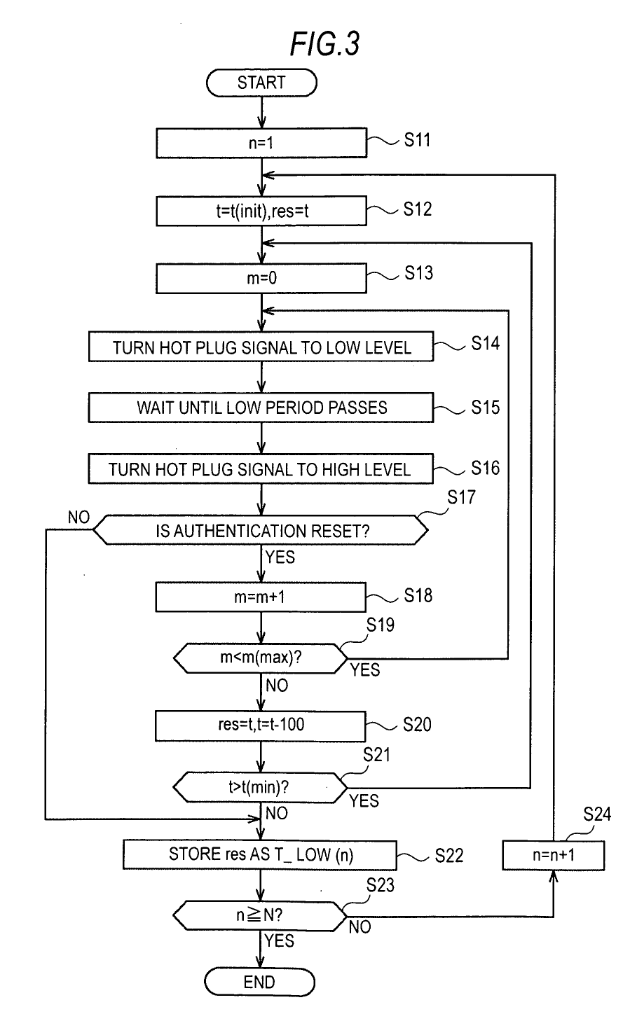

In addition, the memory 14 stores an initial value t(init) of the low period T_LOW of the hot plug signal, the initial value being used in the initial state before a low period optimization process is performed in which the low period T_LOW of the hot plug signal is optimized for each of the HDMI terminals (a process shown in FIG. 3, described later). As the initial value t(init), a sufficiently long time (for example, 1000 milliseconds) is set.

The control unit 15 incorporates therein a CPU (Central Processing Unit), a ROM (Read Only Memory), and a RAM (Random Access Memory). In the control unit 15, the CPU performs a program stored in the ROM, or a program read out of the memory 14 and loaded to the RAM, whereby a process is performed to control each component of the sink device 11.

For example, in the input switching process of switching the source device that inputs a content to the sink device 11, the control unit 15 controls the signal processing unit 13 to switch the outputs (high/low level) of the hot plug signal of the HDMI terminal.

More specifically, suppose that a user manipulates a manipulating unit, not shown, to select one of the HDMI terminals such that the source device connected to the HDMI terminal 12(2), for example, supplies a content to the sink device 11. At this time, the control unit 15 controls the signal processing unit 13 such that the output of the hot plug signal of the HDMI terminal 12(2) is turned to low level for the low period T_LOW (2) milliseconds of the hot plug signal, which is associated with the HDMI terminal 12(2) and stored in the memory 14.

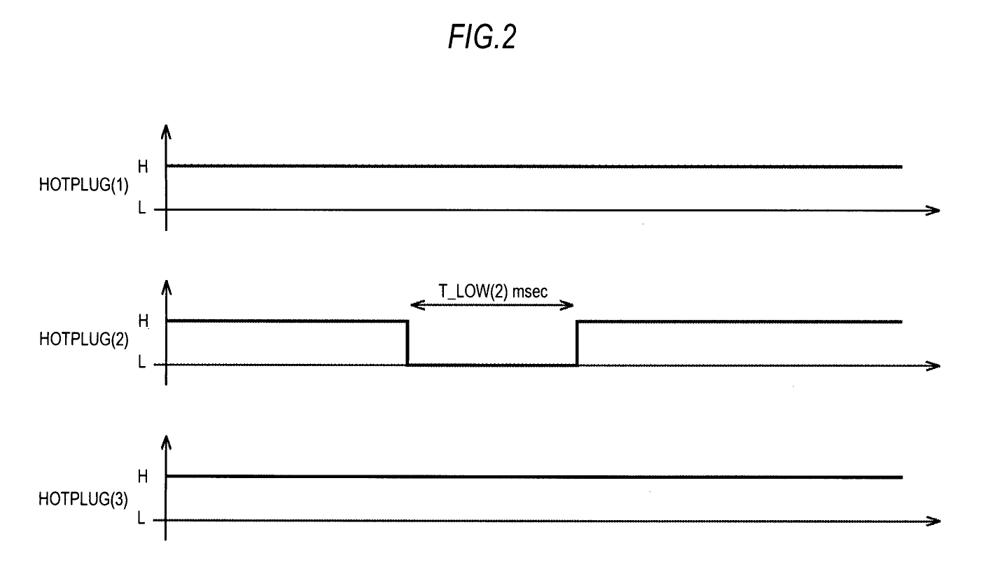

FIG. 2 is a diagram depicting a change in hot plug signals when the HDMI terminal 12(2) is selected in the input switching process.

FIG. 2 shows a hot plug signal Hotplug (1) to a hot plug signal Hotplug (3), which are outputted from the HDMI terminal 12(1) to the HDMI terminal 12(3), respectively. In order to always read EDID of the source devices individually connected to the HDMI terminal 12(1) to the HDMI terminal 12(3), the control unit 15 sets the hot plug signals of all the HDMI terminals to high level all the time.

Then, when the user makes a manipulation to select the HDMI terminal 12(2) to receive a content, in response to the manipulation, the control unit 15 controls the signal processing unit 13 to switch the hot plug signal Hotplug (2) of the HDMI terminal 12(2) from high to low level. Then, the control unit 15 reads the low period T_LOW (2), which is associated with the HDMI terminal 12(2) and stored in the memory 14, turns the hot plug signal Hotplug (2) of the HDMI terminal 12(2) to low level, and then holds the process until the low period T_LOW (2) passes. After that, at the timing at which the low period T_LOW (2) has elapsed, the control unit 15 controls the signal processing unit 13 to switch the hot plug signal Hotplug (2) of the HDMI terminal 12(2) from low to high level.

Thus, the hot plug signal Hotplug (2) of the HDMI terminal 12(2) is low for the low period T_LOW (2) milliseconds. In other words, the signal processing unit 13 changes the hot plug signal Hotplug (2) to be outputted to the source device connected through the HDMI terminal 12(2) from high to low level for the low period T_LOW (2) milliseconds.

Here, when the response time (a time period in which the source device detects that the hot plug signal is turned to low level and responds to it) of the source device connected to the HDMI terminal 12(2) is longer than the low period T_LOW (2) milliseconds, authentication is reset in the source device. Then, to the sink device 11, the source device sends a response including the result of authentication reset and data to send to the sink device 11.

In addition, as described above, the length of the response time of the source device is varied depending on devices. Therefore, the sink device 11 performs the low period optimization process of optimizing the low period of the hot plug signal to each of the source devices connected to the HDMI terminal 12(1) to the HDMI terminal 12(3). Then, in the memory 14, the low period determined in the low period optimization process is stored as associated with each of the HDMI terminal 12(1) to the HDMI terminal 12(3).

For example, the low period optimization process is registered as one item of menu screens displayed on a display (not shown) that displays video outputted from the sink device 11 in conducting various settings of the sink device 11. The user can manipulate the manipulating unit and make an instruction to display a menu screen on the display for performing the low period optimization process.

Next, FIG. 3 is a flowchart illustrative of the low period optimization process of optimizing the low period of the hot plug signal.

When the user makes an instruction to perform the low period optimization process, the process is started. In Step S11, the control unit 15 sets a set value n for identifying the HDMI terminal 12 to one as the initial value, and the process goes to Step S12.

In Step S12, the control unit 15 initializes a trial low period t, which is the low period of the hot plug signal temporarily used in the low period optimization process, and a final result res, which is the low period finally determined as the result in the low period optimization process. In other words, the control unit 15 reads the initial value t(init) of the low period of the hot plug signal (for example, it is a sufficiently long time such as 1000 milliseconds) out of the memory 14, sets the initial value t(init) to the trial low period t, and sets the trial low period t to the final result res.

After the process of Step S12, the process goes to Step S13. The control unit 15 sets a parameter m, which is used in the low period optimization process, to zero, for example, as the initial value, and the process goes to Step S14.

In Step S14, the control unit 15 controls the signal processing unit 13 to switch the hot plug signal Hotplug (n) of an nth HDMI terminal 12(n) from high to low level, and the process goes to Step S15.

In Step S15, the control unit 15 holds the process for the trial low period t, which is initialized in Step S12, or the trial low period t, which is updated in Step S20, described later. Then, when the trial low period t passes after the hot plug signal Hotplug (n) is switched to low level in Step S14, the process goes to Step S16.

In Step S16, the control unit 15 controls the signal processing unit 13 to switch the hot plug signal Hotplug (n) of the HDMI terminal 12(n) from low to high level. In other words, in the processes of Steps S14 to S16, the hot plug signal Hotplug (n) of the HDMI terminal 12(n) is turned to low level for the trial low period t.

After the process of Step S16, the process goes to Step S17. The control unit 15 determines whether authentication is reset in the source device connected to the HDMI terminal 12(n) because the hot plug signal Hotplug (n) of the HDMI terminal 12(n) is turned to low level for the trial low period t in Steps S14 to S16. For example, when the trial low period t is longer than the response time of the source device, the source device detects that the hot plug signal is turned to low level, and resets authentication as well as sends the response to the sink device 11. Therefore, the sink device 11 determines whether the source device sends a response.

In Step S17, if the control unit 15 determines that authentication is not reset, the process goes to Step S22, whereas if the control unit 15 determines that authentication is reset, the process goes to Step S18.

In Step S18, the control unit 15 increments the parameter m by one, and the process goes to Step S19.

In Step S19, the control unit 15 determines whether the parameter m incremented in Step S18 is below a number m(max) preset as the number of times to confirm the occurrence of authentication reset.

In Step S19, if the control unit 15 determines that the parameter m is below the number m(max), the process returns to Step S14, and the similar processes are repeated. In other words, the control unit 15 repeats the process of confirming the occurrence of authentication reset until the control unit 15 confirms the occurrence of authentication reset for the number m(max), or determines that authentication is not reset in Step S17. As described above, the occurrence of authentication reset is confirmed for the number m(max), whereby it can be determined whether the source device stably makes a response.

On the other hand, in Step S19, if the control unit 15 determines that the parameter m is not below the number m(max) (the parameter m is greater than the number m(max)), the process goes to Step S20.

In Step S20, the control unit 15 sets the final result res to the current trial low period t (that is, the trial low period t for which the process is held in Step S14) as well as sets the value obtained by subtracting 100 milliseconds from the current trial low period t to a new trial low period t. In other words, because the source device connected to the HDMI terminal 12(n) is allowed to stably (reliably) reset authentication in the current trial low period t, the control unit 15 updates the trial low period t to a shorter period in order to determine the shortest low period for which the source device connected to the HDMI terminal 12(n) can stably make a response. For example, when the current trial low period t is 500 milliseconds, the control unit 15 sets the final result res to 500 milliseconds as well as sets the new trial low period t to 400 milliseconds.

After the process of Step S20, the process goes to Step S21. The control unit 15 determines whether the trial low period t updated in the previous Step S20 is longer than a minimum value t(min), which is defined as the minimum value for the low period of the hot plug signal. For example, in the HDMI standard, the minimum value t(min) is defined to be 100 milliseconds.

In Step S21, if the control unit 15 determines that the trial low period t is longer the minimum value t(min), the process returns to Step S13, and the similar processes are repeated. In other words, the processes are repeated until it is determined that the source device connected to the HDMI terminal 12(n) reliably makes a response even at the minimum value t(min), or it is determined that authentication is not reset in Step S17.

On the other hand, in Step S21, if the control unit 15 determines that the new low period t does not exceed the minimum value t(min) (that is, the new low period t is equal to or below the minimum value t(min)), the process goes to Step S22. In other words, in this case, the source device connected to the HDMI terminal 12(n) reliably makes a response even at the minimum value t(min).

In Step S22, the control unit 15 associates the final result res with the HDMI terminal 12(n) as the low period T_LOW (n) of the hot plug signal Hotplug (n) optimized to the source device connected to the HDMI terminal 12(n), and stores it in the memory 14.

For example, in Step S21, suppose that it is determined that the trial low period t updated in Step S20 does not exceed the minimum value t(min) and the process goes to Step S22. In this case, the minimum value t(min) that is the final result res at this time is the shortest low period in which the source device connected to the HDMI terminal 12(n) is allowed to stably reset authentication. In other words, in this case, the minimum value t(min) is the optimized low period.

On the other hand, for example, suppose that it is determined that authentication is not reset in Step S17 and the process goes to Step S22. In this case, it is confirmed that the trial low period t in Step S15 does not allow the source device connected to the HDMI terminal 12(n) to reset authentication. Therefore, in this case, the current final result res (that is, the trial low period t finally determined that the source device stably resets authentication) is the shortest low period, for which the source device connected to the HDMI terminal 12(n) is allowed to stably reset authentication. In other words, in this case, the current final result res is the optimized low period.

After the process of Step S22, the process goes to Step S23. The control unit 15 determines whether the set value n for identifying the HDMI terminal 12 is equal to or greater than a number N of the HDMI terminals mounted on the sink device 11 (N=3 in the example shown in FIG. 1). In other words, the control unit 15 determines whether all the HDMI terminals mounted on the sink device 11 have been processed, that is, in the example shown in FIG. 1, whether the HDMI terminal 12(1) to the HDMI terminal 12(3) have been processed.

In Step S23, if the control unit 15 determines that the set value n is still below the number N, there is an HDMI terminal that has not been processed. The process goes to Step S24, and the control unit 15 increments the set value n by one. Then, a subsequent HDMI terminal is set to a target for processing, the process returns to Step S12, and the similar processes are repeated.

On the other hand, in Step S23, if the control unit 15 determines that the set value n is equal to or greater the number N, all the HDMI terminals mounted on the sink device 11 have been processed, and the low period optimization process is ended.

As described above, in the low period optimization process, the sink device 11 can determine the low period in which the source device connected to the HDMI terminal can stably make a response, for each of the HDMI terminal 12(1) to the HDMI terminal 12(3). In other words, the shortest low period can be optimized for each of the source devices.

Therefore, in the input switching process of switching the source device that inputs a content to the sink device 11, processing can be conducted by using the low period optimized for each of the HDMI terminal 12(1) to the HDMI terminal 12(3).

Next, FIG. 4 is a flowchart illustrative of the input switching process of switching the source device that inputs a content to the sink device 11.

For example, when the user specifies (selects) the nth HDMI terminal 12(n) and manipulates the manipulating unit, not shown, such that the source device connected to the HDMI terminal 12(n) inputs a content to the sink device 11, the process is started. In Step S31, based on the signal supplied from the manipulating unit in response to the user manipulation, the control unit 15 controls the signal processing unit 13 such that the content fed through the user specified HDMI terminal 12(n) is outputted. Under control performed by the control unit 15, the signal processing unit 13 switches connection so as to connect the HDMI terminal 12(n) to the circuit in the later stage, not shown.

After the process of Step S31, the process goes to Step S32. The control unit 15 controls the signal processing unit 13 to switch the hot plug signal Hotplug (n) of the HDMI terminal 12(n) from high to low level, and the process goes to Step S33.

In Step S33, the control unit 15 reads the low period T_LOW (n) stored as associated with the HDMI terminal 12(n), that is, the low period T_LOW (n) optimized to the source device connected to the HDMI terminal 12(n) out of the memory 14. The control unit 15 holds the process until the low period T_LOW (n) passes after the hot plug signal Hotplug (n) is turned to low level in Step S32. Then, after the low period T_LOW (n) passes, the process goes to Step S34.

In Step S34, the control unit 15 controls the signal processing unit 13 to switch the hot plug signal Hotplug (n) of the HDMI terminal 12(n) from low to high level. In other words, in the processes of Step S32 to S34, the hot plug signal Hotplug (n) of the HDMI terminal 12(n) is turned to low level for the low period T_LOW (n), and the source device connected to the HDMI terminal 12(n) is requested to reset authentication.

After the process of Step S34, the process goes to Step S35. The signal processing unit 13 receives a response to the request from the sink device 11 sent from the source device that authentication is reset, and supplies the response to the control unit 15.

In addition to the response of authentication reset, the source device having reset authentication sends data signals including resolution information, color space information, and sound information, for example, at predetermined intervals, and the control unit 15 receives the data signals through the signal processing unit 13. Then, the control unit 15 holds the process until the data signals sent from the source device become stable, and after the data signals are stable (for example, after the data signals having the same descriptions are sent for a predetermined number of times), the control unit 15 makes the settings of the display and a speaker (both are not shown) provided in the sink device 11 based on the resolution information, color space information, and sound information included in the data signals. Thus, the sink device 11 can normally output the content supplied from the source device.

After the process of Step S35, the process goes to Step S36. The signal processing unit 13 outputs the content data supplied from the source device to the circuit in the later stage, and the control unit 15 cancels the mute of the display and the amplifier, and starts to output the content. In other words, the control unit 15 allows the display to display video, and allows the speaker to output sounds. After the process of Step S36, the input switching process is ended.

As described above, in the sink device 11, in the input switching process, because the hot plug signal is turned to low level and processing is held for the low period determined in the low period optimization process, the sink device 11 does not need to hold processing for an unnecessarily long time. Therefore, a time period in which a manipulation is made to switch the selection of the source device and the content is outputted can be made shorter than before.

In other words, in the sink device before, because the low period is set as matched with the source device having a long response time, for a source device having a short response time, processing is held for an unnecessarily long time, and it takes a long time to output a content.

In contrast to this, because the sink device 11 optimizes a low period to a source device and uses the low period determined for each source device, it does not unnecessarily take a long time to hold processing for the source device having a short response time. Therefore, a content can be outputted for a proper standby time depending on the response time of the source device. Therefore, a time period for a user has to wait can be shortened, and an excellent response can be made to a manipulation. In other words, the usability of the sink device 11 can be improved.

In addition, because a low period in which a source device can stably make a response can be determined in the low period optimization process even though a source device having a long response time is connected, the sink device 11 can reliably control the source device in connections to any source devices.

In addition, the control unit 15 can perform not only a program preinstalled in the memory 14 but also a program downloaded and installed (updated) in the memory 14 through a communication apparatus, not shown, for example. Therefore, the low period optimization process and the input switching process can be implemented by updating a program performed by means of the control unit 15, and no special hardware is required.

In addition, in the sink device 11, the control unit 15 controls the signals outputted from the HDMI terminal 12(1) to the HDMI terminal 12(3) through the signal processing unit 13, and the control unit 15 can also directly control these signals.

In addition, it is unnecessary to always perform the processes described with reference to the flowcharts in a time series in the described order, and the processes may be performed in parallel or separately (for example, parallel processing or object processing). In addition, a single CPU may process the program, or a plurality of CPUs may process the program in a distributed manner.

In addition, the embodiment of the invention is not limited to the embodiment described above, which can be variously modified within the scope of the teachings of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus comprising:
a connecting means for use in connecting to a different device;
a signal control means for changing a control signal to be outputted to the different device through the connecting means for a predetermined period;
a changing means for changing the predetermined period;
a determining means for determining for each of the predetermined periods changed by the changing means whether the different device stably makes a response to a change in the control signal caused by the signal control means; and
a deciding means for deciding a shortest predetermined period from the predetermined periods determined by the determining means that the different device stably makes a response, as a standby time for the different device connected through the connecting means.

2. The signal processing apparatus according to claim 1, wherein the control signal is always set at high level, and
the signal control means changes the control signal such that the control signal is at low level for the predetermined period.

3. The signal processing apparatus according to claim 1, comprising a plurality of the connecting means,
wherein the deciding means decides the standby time for each of the connecting means.

4. The signal processing apparatus according to claim 3, further comprising a storage means for storing the standby time for each of the connecting means decided by the deciding means as associated with each of the connecting means.

5. The signal processing apparatus according to claim 4, further comprising a requesting means for changing the control signal for the standby time that is associated with the connecting means specified to receive data outputted from the different device and is stored in the storage means, and for requesting the different device connected through the connecting means to reset a predetermined process.

6. The signal processing apparatus according to claim 1, wherein a process performed by the signal control means, the changing means, the determining means, and the deciding means is started according to an instruction made by a user.

7. A signal processing method of a signal processing apparatus for processing a signal, comprising the steps of:
by the signal processing apparatus,
changing a control signal to be outputted to a different device through a connecting means for use in connecting to the different device for a predetermined period;
changing the predetermined period;
determining for each of the changed predetermined period whether the different device stably makes a response to a change in the control signal; and
deciding a shortest predetermined period from the predetermined periods determined that the different device stably makes a response, as a standby time for the different device connected through the connecting means.

8. A program which allows a computer to function as a signal processing apparatus for processing a signal, comprising the functions of:
a signal control means for changing a control signal to be outputted to a different device through a connecting means for use in connecting to the different device for a predetermined period;
a changing means for changing the predetermined period;
a determining means for determining for each of the predetermined periods changed by the changing means whether the different device stably makes a response to a change in the control signal caused by the signal control means; and
a deciding means for deciding a shortest predetermined period from the predetermined periods determined by the determining means that the different device stably makes a response, as a standby time for the different device connected through the connecting means.

9. A signal processing apparatus comprising:
a connecting unit configured to be used in connecting to a different device;
a signal control unit configured to change a control signal to be outputted to the different device through the connecting unit for a predetermined period;
a changing unit configured to change the predetermined period;
a determining unit configured to determine for each of the predetermined periods changed by the changing unit whether the different device stably makes a response to a change in the control signal caused by the signal control unit; and
a deciding unit configured to decide a shortest predetermined period from the predetermined periods determined by the determining unit that the different device stably makes a response, as a standby time for the different device connected through the connecting unit.
